(19) United States
(12) Patent Application Publication
(10) Pub. No.: US 2007/0148565 A1
(43) Pub. Date: Jun. 28, 2007

(54) Method for manufacturing a color filter

(75) Inventor: Ming-Hung Tsai, MiaoLi (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/644,249

(22) Filed: Dec. 22, 2006

(30) Foreign Application Priority Data
Dec. 22, 2005 (CN) 200510121014.X

(51) Int. Cl. G02B 5/20

(52) U.S. Cl. 430/7

(57) ABSTRACT

An exemplary method for manufacturing a color filter, comprising the steps of: providing a substrate; forming a black matrix on the substrate; forming a photo-resist layer on the substrate; and continuously exposing the photo-resist layer using at least three light sources respectively having different wavelengths and developing the photo-resist layer to form color photo-resist layer.

### FIELD OF THE INVENTION

The present invention relates to a method for manufacturing a color filter.

### BACKGROUND

Because a liquid crystal display (LCD) device has the merits of being thin, light in weight, and drivable by a low voltage, it is extensively employed in various electronic devices. A typical LCD device includes a LCD panel. The LCD panel includes two transparent substrates parallel to each other, and a liquid crystal layer disposed between the two substrates. In order to make the liquid crystal display device display a full-colored image, a color filter is usually employed in the device. A typical color filter provides three primary colors: red, green, and blue. The color filter, the liquid crystal layer and a switching element arranged on the substrate cooperate to make the liquid crystal display device display full-colored images.

Referring to FIG. 4, a typical color filter 1 includes a glass substrate 10, a black matrix 11 disposed on the glass substrate 10, and a color photo-resist layer 12 disposed among the black matrix 11. A transparent overcoat layer 13 and a transparent conductive layer 14 are arranged on the black matrix 11 and color photo-resist layer 12, in that sequence. The glass substrate 10 acts as a carrier of the above-mentioned elements. The color photo-resist layer 12 consists of three primary colors: red, green, and blue. The color photo-resist layer 12 includes a plurality of color groups, and each color group includes three primary color portions: a red portion, a green portion, and blue portion, all arranged in a predetermined pattern. The black matrix 11 is disposed among the primary color portions.

When white light reaches the black matrix 11 and color photo-resist layer 12, the red portion allows red rays to pass therethrough, and blocks other rays from passing therethrough. The green portion allows green rays to pass therethrough, and blocks other rays from passing therethrough. The blue portion allows blue rays to pass therethrough, and blocks other rays from passing therethrough. Thus only three colored rays, namely red, green and blue rays, pass through the color photo-resist layer 12.

The black matrix 11 is used to close off light beams from spreading among the primary color portions; that is, to prevent light beams from mixing among the different primary color portions. The transparent overcoat layer 13 is used to planarize the color filter 1. The transparent conductive layer 14 is used to cooperate with a matrix of thin film transistors (not shown) to control quantities of colored rays passing through the color photo-resist layer 12, and thereby to obtain different colors for a displayed image.

In general, the color filter 1 is manufactured according to the following steps:
forming the black matrix 11 on the glass substrate 10, the black matrix 11 being discontinuously distributed thereon;
coating a red color-resist on the glass substrate 10 including the black matrix 11;
exposing and developing the red color-resist to form the red portion of the color photo-resist layer 12;
coating a blue color-resist on the glass substrate 10 including the black matrix 11;
exposing and developing the blue color-resist to form the blue portion of the color photo-resist layer 12;
coating a green color-resist on the glass substrate 10 including the black matrix 11;
exposing and developing the green color-resist to form the green portion of the color photo-resist layer 12;
forming the transparent overcoat layer 13 on the glass substrate 10 including the black matrix 11 and the color photo-resist layer 12; and
forming the transparent conductive layer 14, thereby obtaining the color filter 1.

In above method of manufacturing the color filter, three coating processes and exposing the color-resists processes are needed, which makes the processes complicated. In addition, the red/blue/green color-resists have different ultraviolet (UV) light absorption ratio, so the color photo-resist layer 12 has different heights at red/blue/green portions.

Therefore, a new method for manufacturing a color filter that can overcome the above-described problems are desired.

### SUMMARY

In one embodiment, An exemplary method for manufacturing a color filter, comprising the steps of: providing a substrate; forming a black matrix on the substrate; forming a photo-resist layer on the substrate; and continuously exposing the photo-resist layer using at least three light sources respectively having different wavelengths and developing the photo-resist layer to form color photo-resist layer.

In an alternate embodiment, An exemplary method for manufacturing a color filter, comprising the steps of: providing a substrate; forming a photo-resist layer on the substrate; and respectively exposing the photo-resist layer using at least three light sources having different wavelengths and developing the photo-resist layer to form the color photo-resist layer having red/green/blue portions.

In another alternate embodiment, A method for manufacturing a color filter, comprising the steps of: providing a substrate; forming a photo-resist layer on the substrate; and respectively exposing the photo-resist layer using at least two different light sources having different wavelengths and developing the exposed photo-resist layer to form the color photo-resist layer having different colored photo-resist parts.

Other advantages and novel features of the embodiments will become more apparent from the following detailed description when taken in conjunction with the accompanying drawings; in which:

### BRIEF DESCRIPTION OF THE DRAWINGS

FIG. 1 is a flowchart of a method for manufacturing a color filter in accordance with a first embodiment of the present invention;

FIG. 2 is a flowchart of a method for manufacturing a color filter in accordance with a second embodiment of the present invention;

FIG. 3 is a flowchart of a method for manufacturing a color filter in accordance with a third embodiment of the present invention;

FIG. 4 is a schematic, cross-sectional view of part of a typical color filter; and

FIG. 5 is a flowchart of a method for manufacturing the color filter of FIG. 4.

### DETAILED DESCRIPTION OF PREFERRED EMBODIMENTS

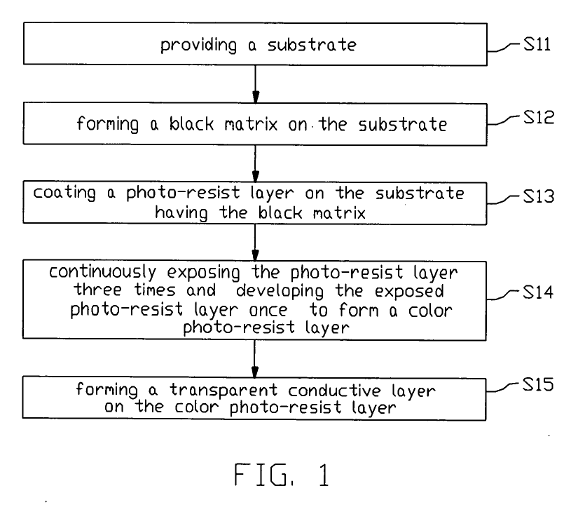

Referring to FIG. 1, a method for manufacturing a color filter according to a first embodiment of the present invention has following processes as follows: S11 providing a substrate; S12 forming a black matrix on the substrate; S13 coating a photo-resist layer on the substrate having the black matrix; S14 continuously exposing the photo-resist layer three times and developing the exposed photo-resist layer once to form a color photo-resist layer; and S15 forming a transparent conductive layer on the color photo-resist layer.

In step S11, a substrate is provided. The glass substrate acts as a carrier of other elements. The substrate is generally made from glass.

In step S12, a black matrix is provided. A photosensitive black organic material is deposited on a transparent insulating substrate, thereby forming a black organic layer. The photosensitive black organic material can be a positive type where portions that are subsequently exposed to light are removed by a development process, or a negative type, such that portions that are subsequently exposed to light are not removed by a development process. In addition, a mask having light-transmitting portions and light-shielding portions is disposed over the black organic layer. Subsequently, light irradiates portions of the black organic layer through the light-transmitting portions of the mask. After developing the light-exposed black organic layer, a black matrix is formed on the transparent insulating substrate. Generally, the black matrix is formed between red/green/blue patterns (sub-color filters) to screen light along a boundary of pixel electrodes. The black matrix is commonly formed of a metal thin film, such as chromium (Cr), a carbon-based organic material having an optical density of more than, a double layer structure of Cr and chromium-oxide (CrOₓ), or photosensitive resin, to form a uniform lower reflection layer. The specific material used for forming the black matrix is commonly based on the material availability.

In step S13, an photo-resist layer is coated on the substrate having the black matrix. The photo-resist layer is generally from 1×10⁻⁶ meters to 2×10⁻⁵ meters, which are bandpass photosensitive material such as polyvinyl alcohol (PVA) or other photosensitive macromolecule material.

In step S14, a color photo-resist layer having red (R), green (G), blue (B) portions is formed on the substrate and the black matrix. A housing having a liquid mercury contained therein is provided, and the photo-resist layer is set to contact with the liquid mercury. After that, three light sources having three different wavelengths are respectively continuously used to expose the photo-resist layer, cooperating with three different masks having different patterns. Next, a developing solution is provided for removing the unexposed photo-resist layer to form a color-resin pattern having red (R), green (G), and blue (B) patterns. In the process, the liquid mercury functions as a carrier to support the substrate and functions as a reflection mirror to reflect light beams incident thereat to intervene with the incident light beams in the photo-resist layer, which the intervene light beams form color photo-resists. The three light sources are partially temporal coherence light sources, which respectively have the wavelengths of 7×10⁻⁷ meters, 5.46×10⁻⁷ meters, and 4.35×10⁻⁷ meters.

In step S15, a transparent conductive layer is formed on the color photo-resist layer to form a color filter substrate. The transparent conductive layer is generally an indium tin oxide (ITO) or indium zinc oxide (IZO).

In the method, only one process for coating the photo-resist layer and one process for developing the exposed photo-resist layer. That is the method for manufacturing the color filter is simplified, comparing to the typical method for manufacturing a color filter. In addition, the color photo-resist layer has a same height at R/G/B patterns because the photo-resist layer for the R/G/B patterns is directly formed on the substrate at one time.

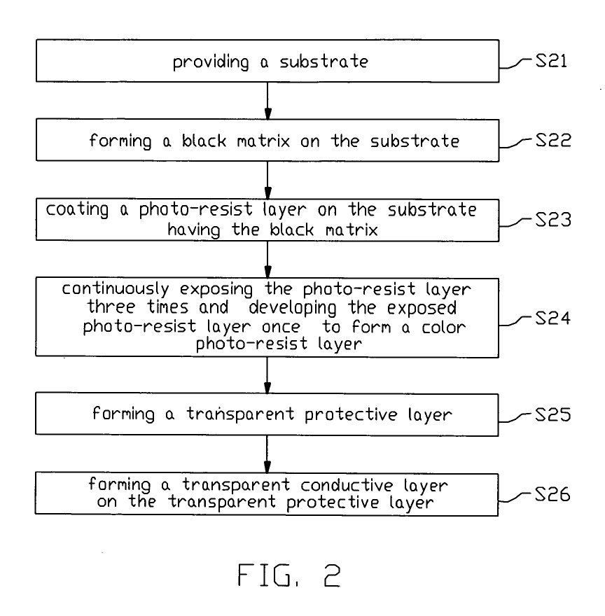

Referring to FIG. 2, a method for manufacturing a color filter according to a second embodiment of the present invention has following processes as follows: S21 providing a substrate; S22 forming a black matrix on the substrate; S23 coating a photo-resist layer on the substrate having the black matrix; S24 continuously exposing the photo-resist layer three times and developing the exposed photo-resist layer once to form a color photo-resist layer; S25 forming a transparent protective layer; and S26 forming a transparent conductive layer on the color photo-resist layer.

In step S21, a substrate is provided. The glass substrate acts as a carrier of other elements. The substrate is generally made from glass.

In step S22, a black matrix is provided. A photosensitive black organic material is deposited on a transparent insulating substrate, thereby forming a black organic layer. The photosensitive black organic material can be a positive type where portions that are subsequently exposed to light are removed by a development process, or a negative type, such that portions that are subsequently exposed to light are not removed by a development process. In addition, a mask having light-transmitting portions and light-shielding portions is disposed over the black organic layer. Subsequently, light irradiates portions of the black organic layer through the light-transmitting portions of the mask. After developing the light-exposed black organic layer, a black matrix is formed on the transparent insulating substrate. Generally, the black matrix is formed between red/green/blue patterns (sub-color filters) to screen light along a boundary of pixel electrodes. The black matrix is commonly formed of a metal thin film, such as chromium (Cr), a carbon-based organic material having an optical density of more than, a double layer structure of Cr and chromium-oxide (CrO.sub.x) or photosensitive resin, to form a uniform lower reflection layer. The specific material used for forming the black matrix is commonly based on the material availability.

In step S23, an photo-resist layer is coated on the substrate having the black matrix. The photo-resist layer is generally from 1×10⁻⁶ meters to 2×10⁻⁵ meters, which are bandpass photosensitive material such as polyvinyl alcohol (PVA) or other photosensitive macromolecule material.

In step S24, a color photo-resist layer is formed on the substrate and the black matrix. A housing having a liquid mercury contained therein is provided, and the photo-resist layer is set to contact with the liquid mercury. After that, three light sources having three different wavelengths are respectively continuously used to expose the photo-resist layer, cooperating with three different masks having different patterns. Next, a developing solution is provided for removing the unexposed photo-resist layer to form a color-resin pattern having red (R), green (G), and blue (B) patterns. In the process, the liquid mercury functions as a carrier to support the substrate and functions as a reflection mirror to reflect light beams incident thereat to intervene with the incident light beams in the photo-resist layer, which the intervene light beams form color photo-resists. The three light sources are partially temporal coherence light sources, which respectively have the wavelengths of 7×10⁻⁷ meters, 5.46×10⁻⁷ meters, and 4.35×10⁻⁷ meters.

In step S25, a transparent protective layer is formed on the color photo-resist layer. The transparent protective layer is made from an epoxy resin, which is used to protect the color photo-resist layer and insulate the black matrix and a subsequently formed transparent conductive layer.

In step S26, a transparent conductive layer is formed on the color photo-resist layer to form a color filter substrate. The transparent conductive layer is generally an indium tin oxide (ITO) or indium zinc oxide (IZO).

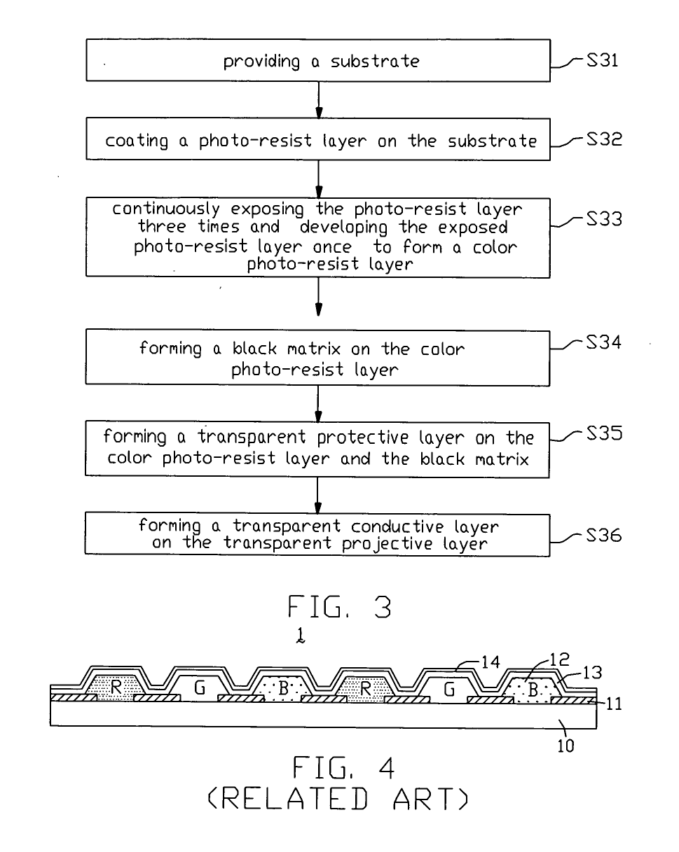

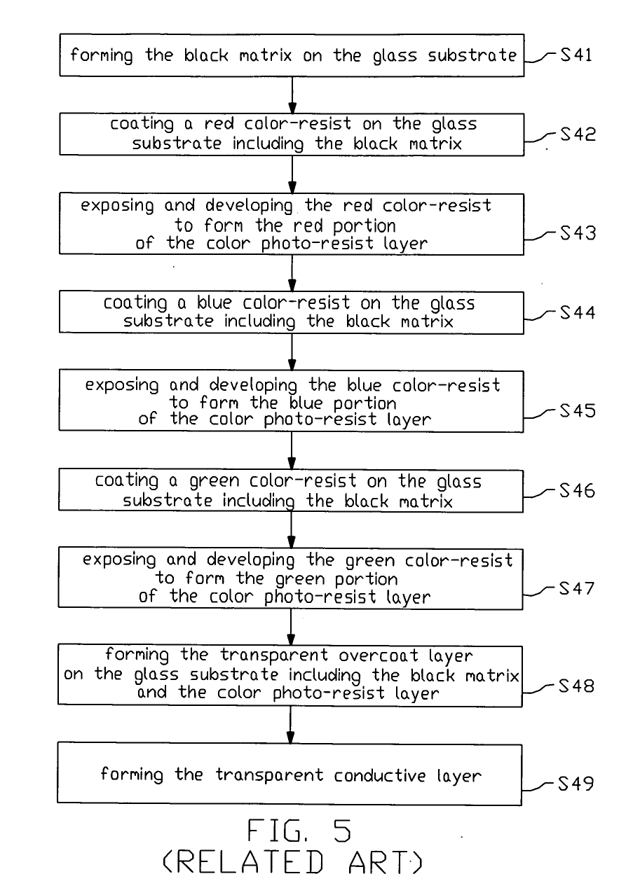

Referring to FIG. 3, a method for manufacturing a color filter according to a second embodiment of the present invention has following processes as follows: S31 providing a substrate; S32 coating a photo-resist layer on the substrate having the black matrix; S33 continuously exposing the photo-resist layer three times and developing the exposed photo-resist layer once to form a color photo-resist layer; S34 forming a black matrix on the color photo-resist layer; S35 forming a transparent protective layer on the color photo-resist layer and the black matrix; and S36 forming a transparent conductive layer on the transparent protective layer.

In step S31, a substrate is provided. The glass substrate acts as a carrier of other elements. The substrate is generally made from glass.

In step S32, an photo-resist layer is coated on the substrate. The photo-resist layer is generally from 1×10⁻⁶ meters to 2×10⁻⁵ meters, which are bandpass photosensitive material such as polyvinyl alcohol (PVA).

In step S33, a color photo-resist layer is formed on the substrate. A housing having a liquid mercury contained therein is provided, and the photo-resist layer is set to contact with the liquid mercury. After that, three light sources having three different wavelengths are respectively continuously used to expose the photo-resist layer, cooperating with three different masks having different patterns. Next, a developing solution is provided for removing the unexposed photo-resist layer to form a color-resin pattern having red (R), green (G), and blue (B) patterns. In the process, the liquid mercury functions as a carrier to support the substrate and functions as a reflection mirror to reflect light beams incident thereat to intervene with the incident light beams in the photo-resist layer, which the intervene light beams form color photo-resists. The three light sources are partially temporal coherence light sources, which respectively have the wavelengths of 7×10⁻⁷ meters, 5.46×10⁻⁷ meters, and 4.35×10⁻⁷ meters.

In step S34, a black matrix is provided on the color photo-resist layer. A photosensitive black organic material is deposited on a transparent insulating substrate, thereby forming a black organic layer. The photosensitive black organic material can be a positive type where portions that are subsequently exposed to light are removed by a development process, or a negative type, such that portions that are subsequently exposed to light are not removed by a development process. In addition, a mask having light-transmitting portions and light-shielding portions is disposed over the black organic layer. Subsequently, light irradiates portions of the black organic layer through the light-transmitting portions of the mask. After developing the light-exposed black organic layer, a black matrix is formed on the transparent insulating substrate. Generally, the black matrix is formed between red/green/blue patterns (sub-color filters) to screen light along a boundary of pixel electrodes. The black matrix is commonly formed of a metal thin film, such as chromium (Cr), a carbon-based organic material having an optical density of more than, or a double layer structure of Cr and chromium-oxide (CrO.sub.x), to form a uniform lower reflection layer. The specific material used for forming the black matrix is commonly based on the material availability.

In step S35, a transparent protective layer is formed on the color photo-resist layer and the black matrix. The transparent protective layer is made from an epoxy resin, which is used to protect the color photo-resist layer and insulate the black matrix and a subsequently formed transparent conductive layer.

In step S36, a transparent conductive layer is formed on the color photo-resist layer to form a color filter substrate. The transparent conductive layer is generally an indium tin oxide (ITO) or indium zinc oxide (IZO).

The above-described method for manufacturing the color filter can simplify the processes. Firstly, only one process for coating photo-resist layer is needed and only one process for developing three exposed photo-resist portions is needed. That is the process for manufacturing the color filter is simplified, and costs are reduced. Consequently, the color photo-resist layer has a same height at R/G/B portions. Thus, an overcoat layer isn't needed. When no overcoat layer is needed, the process for manufacturing the color filter is further simplified, and costs are reduced. Additionally, when the overcoat layer is omitted, a thickness of the color filter is reduced. This can increase a light transmittance of the color filter.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a color filter, comprising the steps of:
providing a substrate;
forming a black matrix on the substrate;
forming a photo-resist layer on the substrate; and
continuously exposing the photo-resist layer using at least three light sources respectively having different wavelengths and developing the photo-resist layer to form color photo-resist layer.

2. The method according to claim 1, wherein the light sources are partially temporal coherence light sources.

3. The method according to claim 1, wherein the light sources are three, which respectively have the wavelengths of 7×10⁻⁷ meters, 5.46×10⁻⁷ meters, and 4.35×10⁻⁷ meters.

4. The method according to claim 1, wherein a liquid mercury is provided, which functions as a carrier to support the substrate having the photo-resist layer.

5. The method according to claim 4, wherein the photo-resist layer contacts the liquid mercury, which the liquid mercury functions as a reflection mirror to reflect light beams incident thereat to intervene with the incident light beams in the photo-resist layer.

6. The method according to claim 1, wherein the photo-resist layer is bandpass photosensitive material.

7. The method according to claim 6, wherein the photo-resist layer is polyvinyl alcohol (PVA).

8. The method according to claim 1, further comprising a process of forming a transparent protective layer on the color photo-resist layer.

9. The method according to claim 8, further comprising a process of forming a transparent conductive layer on the transparent protective layer.

10. The method according to claim 1, wherein the transparent conductive layer is an indium tin oxide (ITO) or indium zinc oxide (IZO).

11. The method according to claim 1, wherein the blackmatrix is made from photosensitive resin or Cr.

12. The method according to claim 1, wherein the photo-resist layer has a thickness from 1×10⁻⁶ meters to 2×10⁻⁵.

13. A method for manufacturing a color filter, comprising the steps of:
providing a substrate;
forming a photo-resist layer on the substrate; and
respectively exposing the photo-resist layer using at least three light sources having different wavelengths and developing the photo-resist layer to form the color photo-resist layer having red/green/blue portions.

14. The method according to claim 13, further comprising a process of forming a black matrix on the color photo-resist layer;

15. The method according to claim 14, further comprising a process of forming a transparent protective layer on the black matrix and the color photo-resist layer.

16. The method according to claim 15, further comprising a process of forming a transparent conductive layer on the transparent protective layer.

17. A method for manufacturing a color filter, comprising the steps of:
providing a substrate;
forming a photo-resist layer on the substrate; and
respectively exposing the photo-resist layer using at least two different light sources having different wavelengths and developing the exposed photo-resist layer to form the color photo-resist layer having different colored photo-resist parts.

18. The method according to claim 17, further comprising a process of forming a black matrix before or after the color photo-resist layer is provided.

19. The method according to claim 17, wherein a liquid mercury is provided, which functions as a carrier to support the substrate having the photo-resist layer.

20. The method according to claim 19, wherein the photo-resist layer contacts the liquid mercury, which the liquid mercury functions as a reflection mirror to reflect light beams incident thereat to intervene with the incident light beams in the photo-resist layer.
